(19) United States
(12) Patent Application Publication
(10) Pub. No.: US 2006/0180400 A1
(43) Pub. Date: Aug. 17, 2006

(54) Industrial truck having a foldable order board

(76) Inventor: Michael Schonauer, Moosburg (DE)

Correspondence Address: EDWARDS & ANGELL, LLP, P.O. BOX 55874, BOSTON, MA, 02205, US

(21) Appl. No.: 11/190,439

(22) Filed: Jul. 27, 2005

(30) Foreign Application Priority Data
Aug. 18, 2004 (DE) 10 2004 040 063.6

(51) Int. Cl. B66F 9/06

(52) U.S. Cl. 187/222

(57) ABSTRACT

The invention provides an industrial truck (10), in particular an order-picking stacker, which is provided with a sheet-holding device (30) which is mounted on a supporting structure (21) in the region of a driver's platform (20) on the industrial truck (10). A writing surface (32) of the sheet-holding device (30) can be displaced between a storage position and a use position along a displacement path and can be fixed in at least the use position. Furthermore, a force-exerting device (42) is provided which exerts a force (F) on the sheet-holding device (30) when the sheet-holding device (30) is displaced at least along a section of the displacement path (V) in at least one displacement direction, advantageously in both displacement directions, said force having a force component (Fᵥ, F_{v′}) which is effective in the displacement direction.

The invention relates to an industrial truck, in particular an order-picking stacker or an order-picker, having a sheet-holding device which is mounted on a supporting structure of the industrial truck, can be displaced between a storage position and a use position along a displacement path and can be fixed in at least the use position.

It is known in the case of industrial trucks to provide a sheet-holding device on the driver's platform, on which sheet-holding device, for example, a list of goods to be transported can be held such that the driver of the industrial truck can check his work progress during operation and can possibly make a note of which goods have already arrived at their destination and which still need to be assembled.

These known sheet-holding devices, which are also referred to as order boards, can be mounted vertically or horizontally such that they are fixed in the region of the driver's platform. This has the disadvantage that although horizontally mounted sheet-holding devices provide a comfortable writing surface at an appropriate mounting height, they may protrude into the area of the driver's platform and thus impede the driver in his work and possibly even represent a risk of injury. Vertically mounted order boards avoid the risk of injury and the undesirable decrease in space on the driver's platform, but do not provide a comfortably usable writing surface for the driver, and pens using ink fluid, such as ballpoint pens, may fail to write on a vertical surface.

Sheet-holding devices of the type mentioned initially are also known which can be displaced between a generally vertical storage position and a use position and can be fixed in each of these positions using a butterfly nut. This has the advantage that the sheet-holding device can be accommodated in the storage position such that it takes up as little space as possible on the driver's platform, is therefore not in the way of the driver and does not represent a risk of injury, and can provide a comfortable writing position in the use position. The displacement of these sheet-holding devices, however, is complex for the user and cannot be carried out single-handedly.

It is therefore an object of the present invention to provide such a sheet-holding device for an industrial truck which can be displaced by a user with little complexity, in particular single-handedly.

This object is achieved by a generic industrial truck, in the case of which a force-exerting device is provided which exerts a force on the sheet-holding device when the sheet-holding device is displaced at least along a section of the displacement path in at least one displacement direction, advantageously in both displacement directions, said force having a force component which is effective in the displacement direction.

The force-exerting device provided according to the invention ensures that the displacement movement is assisted or, depending on the performance of the force-exerting device, is brought about in at least one displacement direction at least along a section of the displacement path, and that it is therefore made easier for the driver of the industrial truck to displace the sheet-holding device.

Since an operator of the industrial truck sometimes requires the sheet-holding device to be in the use position for a short period of time in order to record urgent notes, the at least one displacement direction which is assisted by the force-exerting device is preferably the displacement direction from the storage position to the use position. Restoring the sheet-holding device to the storage position can take place without any time pressure once the notes have been made.

In order to provide high efficiency, however, it is advantageous if the operator does not expend an unnecessarily long period of time on storing the sheet-holding device, which means that consideration is advantageously given to designing the force-exerting device such that it assists displacement of the sheet-holding device in both one and the other displacement direction.

In this case, it is also advantageous if the force-exerting device is designed such that the force component which assists or even brings about displacement of the sheet-holding device acts on the sheet-holding device in an end section of the displacement path, this end section comprising an end position of the sheet-holding device. For the abovementioned reasons, a preferred end position is the use position. However, it is particular advantageous if the force-exerting device exerts a corresponding force on the sheet-holding device both in the use position and in the storage position as the end positions. In these cases, a force exerted on the sheet-holding device by the force-exerting device during displacement of said sheet-holding device continues to have an effect with a force component which is effective towards the end position, such that the force-exerting device prestresses the sheet-holding device into the respective end position. As a result, by suitably selecting and/or arranging the force-exerting device, the sheet-holding device can be fixed as described above in the respective end position, preferably in the use position, without any further locking means.

In this case, the force can be adjusted such that the force-exerting device fixes the sheet-holding device in each case in the desired end position without a separate fixing device being required, such that it is not pushed substantially out of the desired end position owing to low forces, as occur, for example, in the use position when the sheet-holding device is written on. Any slight give or resilience in the sheet-holding device in the use position during writing is thereby tolerated. Electrical, electromagnetic, hydraulic, pneumatic or mechanical force-exerting devices may be provided, for example, as the force-exerting device.

Since the sheet-holding device in accordance with the above advantageous development of the invention can be fixed at least in the use position by means of the force component exerted by the force-exerting device, single-handed actuation of the sheet-holding device for the purpose of displacing it to the use position is possible, since manual displacement need only take place until the sheet-holding device is located in the force-assisting section of the displacement path. From then on, further displacement can take place automatically given a force-exerting device with sufficient dimensions. For a displacement out of the respective end position which is fixed by the force-exerting device, only the force component of the force-exerting device which counteracts a displacement movement need then be overcome. Additional intervention with the aim of fixing/releasing the sheet-holding device is not required.

The supporting structure, on which the sheet-holding device is mounted, may be a support structure on the driver's platform, a rear wall of the driver's platform, or any other desired structure of the industrial truck which is suitable for accommodating a sheet-holding device. The term “driver's platform” in this case encompasses both a driver's platform which is fixed to the frame and a driver's station support which moves along with the load means.

The force-exerting device advantageously comprises a spring element. This may be, for example, a helical compression spring. The spring element preferably comprises a gas compression spring which provides a very large spring path with a small space requirement. A simple, cost-effective and robust force-exerting device can thus be provided.

An advantageous force effect of the force-exerting device on the sheet-holding device such that said sheet-holding device can be fixed both in the use position and in the storage position by the spring element can be realized in a simple manner in design terms by the spring element being articulated both on the supporting structure and on the sheet-holding device such that it can rotate about essentially parallel axes of rotation, the spring element carrying out a rotary movement about the point at which it is articulated on the supporting structure, said rotary movement passing through a dead center position of the spring element, during the displacement movement of the sheet-holding device between the storage position and the use position. The dead center position is in this case defined by a position in which the spring element is compressed to a maximum extent, in which no component of the spring force acts in the displacement direction, and in which the direction of action of the force component, which is effective parallel to the displacement path and always points away from the dead center, is reversed. When there is a rotary movement about the point at which it is articulated on the supporting structure, the spring element is therefore initially compressed in order to achieve its maximum compression at the dead center, and can then expand again in order to assist the further displacement movement on that section of the displacement path which is downstream of the dead center in the respective displacement direction. A user of the sheet-holding device will therefore need to exert a force, counter to a spring force of the spring element, in the first section of the displacement path up to the dead center until, once the dead center has been overcome, a force component of the spring element acts in the displacement direction such that the sheet-holding device is either pushed automatically into the desired position or at least the displacement force which needs to be used by the user is only very low.

Since the intention is for it to be possible in the use position to write on the sheet-holding device without the sheet-holding device being substantially removed from its position, the beyond-dead center mechanism is preferably designed such that a holding force for fixing the sheet-holding device in the use position is greater than forces which are usually effective when writing on a writing surface of the sheet-holding device. This can be achieved by matching the prestress of the spring element and by suitably selecting the length of the displacement path sections between the use position and the dead center on the one hand and between the storage position and the dead center on the other hand. In order to make it easier to displace the sheet-holding device from the storage position to the use position, a holding force which is effective in the storage position may be lower than a holding force which is effective in the use position.

Provision may furthermore be made for the movement of the sheet-holding device between the storage position and the use position to comprise a pivotal movement, or preferably to be a pivotal movement.

Provision may furthermore be made in the context of the invention for the storage position to be a position of the sheet-holding device which is closer to the supporting structure of the industrial truck, and for the use position to be a position of the sheet-holding device which is further away from the supporting structure of the industrial truck. This has the advantage that, in the storage position, the sheet-holding device protrudes as little as possible into an area of the driver's platform and thus does not impede the driver or represent a risk of injury. Provision may furthermore be made for a depression to be provided in the supporting structure, which depression partially or completely accommodates the sheet-holding device in the storage position such that no projecting edges of the sheet-holding device protrude into the driver's platform for the purpose of additionally avoiding any risk of injury.

When attaching the sheet-holding device in a region between just above the waist level and approximately the eye level of an operator of the industrial truck, the angle of inclination, which is the most favorable in ergonomic terms depending on the attachment level, with respect to a standing area for the industrial truck is between 30 and 60° for the use position of the sheet-holding device. In this angular range, it is also ensured that pens using ink fluid, such as ballpoint pens, can be used for writing on the writing surface of the sheet-holding device. If the sheet-holding device is expediently attached approximately at or just below the shoulder level of a driver, an angle of inclination of the writing surface in the use position of 40 to 50°, and in particular of approximately 45°, is the most favorable in ergonomic terms.

The sheet-holding device may comprise at least one handle which may preferably be in the form of a trough-like handle depression. By means of the handle, the sheet-holding device can be displaced easily, in particular even single-handedly, between the use position and the storage position, a trough-like handle depression also being suitable as a storage area, for example for accommodating small parts.

The sheet-holding device may furthermore comprise at least one cutout, for example for the purpose of accommodating writing utensils. In addition, at least one clamping device may be provided for the purpose of holding sheets.

In addition, the invention relates generally to a writing support which comprises a holding structure for the purpose of being fixed to a substructure and a sheet-holding device which can be displaced in relation to the holding structure between a storage position and a use position along a displacement path and can be fixed in at least the use position, a force-exerting device being provided between the holding structure and the sheet-holding device which exerts a force on the sheet-holding device when the sheet-holding device is displaced at least along a section of the displacement path in at least one displacement direction, advantageously in both displacement directions, said force having a force component which is effective in the displacement direction.

In this case, the holding structure of the sheet-holding device may comprise, for example, a mounting plate, by means of which the sheet-holding device can be mounted on any desired fixed surface or structure, and the sheet-holding device may furthermore be designed to have one of the abovementioned features.

An embodiment of the present invention will be explained by way of example below with reference to the attached drawings, in which:

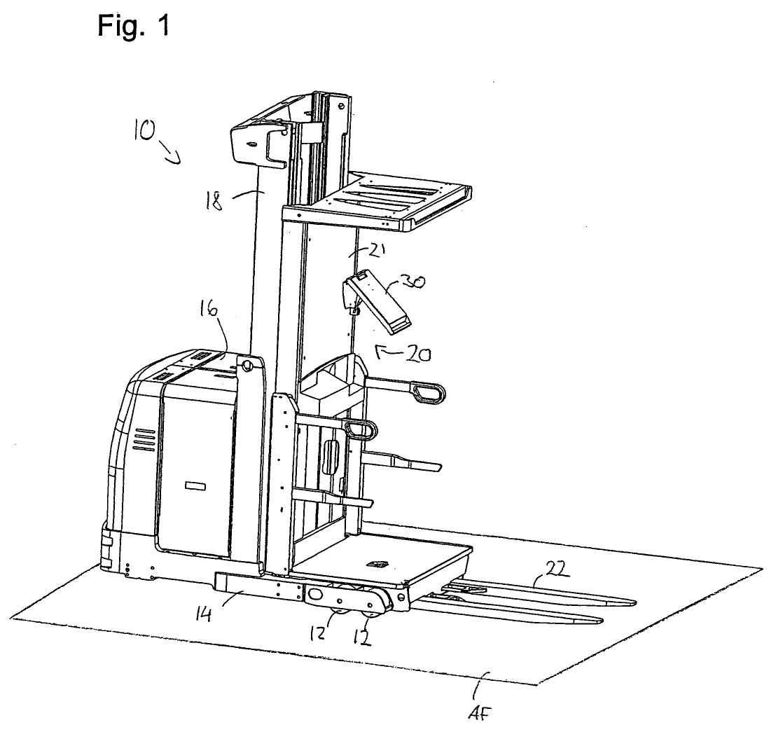

FIG. 1 shows a perspective view of an industrial truck according to the invention having a sheet-holding device;

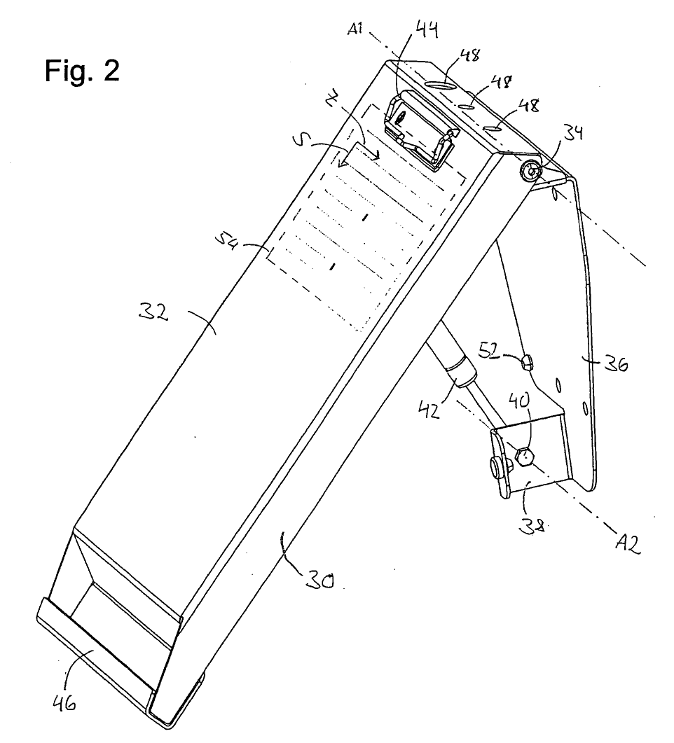

FIG. 2 shows a perspective view of the sheet-holding device shown in FIG. 1; and

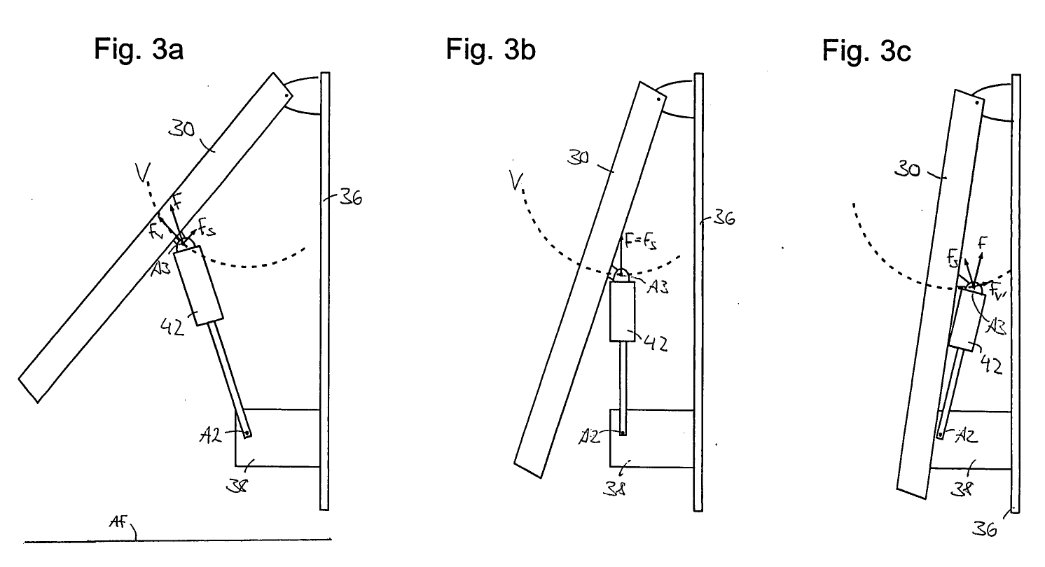

FIGS. 3a-c show a schematic illustration of a displacement movement of the sheet-holding device shown in FIGS. 1 and 2.

The industrial truck shown in FIG. 1 is a so-called order-picker 10 having a chassis 14 which is supported on running wheels 12 and stands on an essentially planar standing area AF. A rear running wheel (not shown) can be steered. An electromotive transport drive, accumulators for the purpose of supplying electrical power and hydraulic components for driving a driver's platform 20 which can be moved vertically in a controlled manner on a lifting mast 18 are provided under the hood 16 in the rear region of the order-picker 10. A load means 22 is attached to the driver's platform 20 and its height can be adjusted hydraulically together with the driver's platform. In the region of the driver's platform 20, a sheet-holding device 30, which will be explained in more detail below with reference to FIG. 2, is provided on a supporting structure 21, such as a support or a rear wall of the driver's platform.

FIG. 2 shows the sheet-holding device 30 in its use position. The sheet-holding device 30 is fixed on a mounting plate 36 by means of bolts 34 such that it can pivot about a pivot axis A1 and comprises a writing surface 32 on which, as indicated by a dashed outline, a sheet 54 with writing on it is arranged. The pivot axis A1 of the sheet-holding device 30 may in this case in principle be aligned either parallel to a row direction Z of the written-on sheet 54 which is arranged on the writing surface 32 or perpendicular thereto, along a column direction S. A pivot axis A1, which is parallel to a row direction Z (as illustrated in FIG. 2), has the advantage that the writing surface 32 is always aligned parallel to the standing area AF of the industrial truck 10 in the row direction Z, irrespective of the displacement angle of the sheet-holding device 30, such that it is possible at any displacement angle to write in a row direction Z which is parallel to the standing area AF. In contrast thereto, in the case of a pivot axis A1 which is arranged parallel to the column direction S it would only be ensured at a single displacement angle that the row direction Z of the writing surface 32 is aligned parallel to the standing area of the industrial truck 10, i.e. comfortable writing would only be possible at a single displacement angle. Should the displacement angle of the sheet-holding device 30 in the use position be changed, for example owing to wear on the spring element 42, with the preferred arrangement of the pivot axis A1 parallel to the row direction Z it is therefore ensured in any case that comfortable writing is possible despite a different angle of inclination of the sheet-holding device 30 in the use position.

The mounting plate 36 comprises a projecting section 38, to which an end of a gas compression spring 42 is attached by means of a bolt 40 such that it can pivot about an axis A2. The other end of the gas compression spring 42 is fixed on the sheet-holding device 30 such that it can pivot about an axis A3 (cf. FIGS. 3a-c) by means of a hinge arrangement which is not illustrated in any more detail. The pivot axes A2 and A3 are in this case parallel to one another.

In addition, a sheet clamp 44, a trough-like handle depression 46 and cutouts 48 are provided on the sheet-holding device 30. The handle depression 46 in this case at the same time acts as a handle and as a storage trough for small parts. The cutouts 48 which may alternatively also be formed in the mounting plate 36 may serve the purpose of accommodating writing utensils.

The mounting plate 36 has mounting holes 50 in order to be fixed to a supporting structure, for example of the industrial truck 10, by means of bolts 52.

As can be seen in FIG. 2, the sheet-holding device 30 is held in the use position by the force of the gas compression spring 42 which acts counter to a displacement in the direction of the mounting plate 36. In this case, the maximum deflection of the gas compression spring 42 is limited by a stopper or the like on the gas compression spring piston, such that the sheet-holding device 30 cannot be pivoted upwards beyond the use position illustrated by means of the gas compression spring 42. The fixing force of the gas compression spring 42 is in this case selected such that the sheet-holding device 30 can be pushed downwards only slightly out of the use position if a user exerts a slight pressure (typical of writing) on the writing surface 32. On the other hand, however, the fixing force of the gas compression spring 42 is selected to be small enough for a user to be able to overcome this fixing force by applying single-handed pressure to the handle 46 and can move the sheet-holding device 30 into the storage position in which the writing surface 32 is aligned essentially parallel to the mounting plate 36. In this case, the arrangement of the handle depression 46 on the side which is remote from the pivot axis A1 of the sheet-holding device 30 is advantageous since it is thus possible for the forces required for displacing the sheet-holding device 30 to be reduced by a large lever transmission of the long lever arm of the handle depression 46 with respect to the shorter lever arm of the gas compression spring 42.

The mounting plate 36 and the spring fixing section 38 projecting from it may be produced integrally from a metal sheet, for example by means of stamping and bending. The sheet-holding device 30 may be formed integrally from a bent metal sheet, including the base wall of the handle depression 46. Alternatively, the sheet-holding device 30 may be produced together with the handle depression 46 in one or more parts from plastic.

FIGS. 3a to c explain the beyond-dead center mechanism of the sheet-holding device 30. FIG. 3a in this case shows the sheet-holding device 30 in the use position in which the writing surface 32 is inclined by approximately 45° with respect to the standing area AF of the industrial truck 10. The standing area AF of the industrial truck 10 is in this case a suitable reference plane, since it is important for a comfortable writing position that the writing surface 32 is inclined at an angle which is favorable in ergonomic terms in relation to the base of the driver's platform 20 and that the base of the driver's platform 20 is generally aligned parallel to the standing area AF of the industrial truck 10.

A displacement path V, which is passed through by the upper end of the gas compression spring 42 which is articulated on the sheet-holding device 30, is indicated by a dashed line. The force F exerted by the gas compression spring 42 can be broken down into a component Fᵥ along a tangent on the displacement path V and a component F_{S} perpendicular to the tangent on the displacement path V. This makes it clear that the gas compression spring 42 fixes the sheet-holding device 30 in the use position such that the writing surface 32 is only slightly removed from the use position even if a low pressure is applied, for example when writing, and such that, in the event of a slight displacement from the use position, springs back into this position again. In order to displace the sheet-holding device 30 from the use position to the storage position, a force needs to be applied to the handle depression 46 which overcomes the component Fᵥ of the force F produced by the gas compression spring 42. Owing to the large lever arm of the handle depression 46 which is arranged at that end of the sheet-holding device 30 which is remote from the pivot axis, this force, when compared with the lever arms, is smaller than the holding force Fᵥ exerted by the gas compression spring.

FIG. 3b shows the sheet-holding device 30 in an intermediate position between the use and the storage position in which the dead center of the gas compression spring 42 has just been reached. At this dead center, the gas compression spring 42 is compressed to a maximum extent, i.e. at this point the distance between the displacement path V and the lower articulation point of the gas compression spring 42 on the section 38 of the mounting plate 36 is minimal. The force F produced by the gas compression spring 42 does not have any force component effective in the direction of a tangent on the displacement path at the dead center, with the result that the sheet-holding device 30 at this point is pushed by the gas compression spring 42 neither in the direction of the use position nor in the direction of the storage position. When the sheet-holding device 30 is displaced from the use position to the storage position, the user therefore needs to overcome the force component Fᵥ of the spring force F which acts in the opposite direction to the displacement direction only along the displacement path section from the use position to the dead center.

FIG. 3c shows the storage position of the sheet-holding device 30. In the storage position, the gas compression spring 42 is rotated in the counterclockwise direction beyond its dead center, such that the spring force F now again has a force component F_{v′} which acts along the displacement path V in a direction towards the mounting plate 36 and therefore fixes the sheet-holding device 30 in the storage position with this force F_{v′.}

By suitably adjusting the prestress of the gas compression spring 42 and the length and the position of the displacement path sections on both sides of the dead center, it is possible to achieve a situation in which the holding force F_{v′}, which fixes the sheet-holding device 30 in the storage position, is lower than the holding force Fᵥ which fixes the sheet-holding device 30 in the use position. This has the advantage that the force required for displacing the sheet-holding device 30 from the storage position to the use position is reduced since only the lower force F_{v′}, needs to be overcome on the displacement path section from the storage position to the dead center, whereas the retaining force Fᵥ is sufficient in the use position of the sheet-holding device 30 in order to fix the writing surface 32 essentially in the use position even when a slight pressure is applied, such as when writing. A holding force F_{v′} which is exerted in the storage position, on the other hand, need only be high enough to fix the sheet-holding device 30 against any undesired automatic movement from the storage position.

1. An industrial truck, in particular an order-picking stacker, having a sheet-holding device which is mounted on a supporting structure of the industrial truck, can be displaced between a storage position and a use position along a displacement path and can be fixed in at least the use position, wherein a force-exerting device is provided which exerts a force (F) on the sheet-holding device when the sheet-holding device is displaced at least along a section of the displacement path (V) in at least one displacement direction, advantageously in both displacement directions, said force having a force component (Fᵥ, F_{v′}) which is effective in the displacement direction.

2. The industrial truck as claimed in claim 1, wherein the force-exerting device comprises a spring element.

3. The industrial truck as claimed in claim 2, wherein the spring element comprises a gas compression spring.

4. The industrial truck as claimed in claim 2, wherein the spring element is articulated both on the supporting structure and on the sheet-holding device such that it can rotate about essentially parallel axes of rotation, the spring element carrying out a rotary movement about the point at which it is articulated on the supporting structure, said rotary movement passing through a dead center position of the spring element, during the displacement movement of the sheet-holding device between the storage position and the use position.

5. The industrial truck as claimed in claim 1, wherein the movement of the sheet-holding device between the storage position and the use position comprises a pivotal movement, preferably is a pivotal movement.

6. The industrial truck as claimed in claim 1, wherein the storage position is a position of the sheet-holding device which is closer to the supporting structure of the industrial truck, and the use position is a position of the sheet-holding device which is further away from the supporting structure of the industrial truck.

7. The industrial truck as claimed in claim 1, wherein, in the use position, the sheet-holding device is inclined by 30° to 60°, preferably by 40° to 50° and particularly preferably by approximately 45° with respect to a standing area for the industrial truck.

8. The industrial truck as claimed in claim 1, wherein the sheet-holding device comprises at least one handle.

9. The industrial truck as claimed in claim 8, wherein at least one of the handles of the sheet-holding device is in the form of a trough-like handle depressions.

10. The industrial truck as claimed in claim 1, wherein the sheet-holding device comprises at least one cutout for at least the purpose of accommodating writing utensils.

11. The industrial truck as claimed in claim 1, wherein the sheet-holding device comprises at least one clamping device for at least the purpose of holding sheets.

12. A writing support which comprises a sheet-holding device and a holding structure, it being possible for the sheet-holding device to be displaced in relation to the holding structure between a storage position and a use position along a displacement path (V) and to be fixed in at least the use position, wherein a force-exerting device is provided which exerts a force (F) on the sheet-holding device when the sheet-holding device is displaced at least along a section of the displacement path (V) in at least one displacement direction, advantageously in both displacement directions, said force (F) having a force component (Fᵥ, F_{v′}) which is effective in the displacement direction.

13. (canceled)

14. The industrial truck as claimed in claim 12, wherein the force-exerting device comprises a spring element.

15. The industrial truck as claimed in claim 14, wherein the spring element comprises a gas compression spring.

16. The industrial truck as claimed in claim 14, wherein the spring element is articulated both on the supporting structure and on the sheet-holding device such that it can rotate about essentially parallel axes of rotation, the spring element carrying out a rotary movement about the point at which it is articulated on the supporting structure, said rotary movement passing through a dead center position of the spring element, during the displacement movement of the sheet-holding device between the storage position and the use position.

17. The industrial truck as claimed in claim 12, wherein the movement of the sheet-holding device between the storage position and the use position comprises a pivotal movement, preferably is a pivotal movement.

18. The industrial truck as claimed in claim 12, wherein the storage position is a position of the sheet-holding device which is closer to the supporting structure of the industrial truck, and the use position is a position of the sheet-holding device which is further away from the supporting structure of the industrial truck.

19. The industrial truck as claimed in claim 12, wherein, in the use position, the sheet-holding device is inclined by 30° to 60°, preferably by 40° to 50° and particularly preferably by approximately 45° with respect to a standing area for the industrial truck.

20. The industrial truck as claimed in claim 12, wherein the sheet-holding device comprises at least one handle.

21. The industrial truck as claimed in claim 20, wherein at least one of the handles of the sheet-holding device is in the form of a trough-like handle depression.

22. The industrial truck as claimed in claim 12, wherein the sheet-holding device includes means for accommodating writing utensils.

23. The industrial truck as claimed in claim 12, wherein the sheet-holding device includes means for holding sheets.
